(19) United States
(12) Patent Application Publication
(10) Pub. No.: US 2010/0226370 A1
(43) Pub. Date: Sep. 9, 2010

(54) NETWORK SYSTEM

(75) Inventors: Yukihisa TAMURA, Yokohama (JP); Koji TAKATORI, Tokyo (JP); Masatoshi SHIBASAKI, Yokohama (JP); Toshiyuki ATSUMI, Kamakura (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/612,381

(22) Filed: Nov. 4, 2009

(30) Foreign Application Priority Data
Mar. 6, 2009 (JP) 2009-052817

(51) Int. Cl. H04L 12/56; H04J 3/24

(52) U.S. Cl. 370/392; 370/474

(57) ABSTRACT

When label switching is performed on a conventional MPLS packet, a bit error may occur in an MPLS label header of the MPLS packet and user data may misdelivered. To avoid such misdelivery of the user data, an HEC function is attached to the MPLS label header.

### INCORPORATION BY REFERENCE

The present application claims priority from Japanese applications JP2009-052817 filed on Mar. 6, 2009, the content of which is hereby incorporated by reference into this application.

### BACKGROUND OF THE INVENTION

The present invention relates to a technical field of a multi-protocol label switching (MPLS) network that allows a packet to be transferred by means of label switching with high reliability by preventing a misdelivery of the packet.

In recent years, communication carriers' backbone networks have been developed into full IP (Internet Protocol) Ethernet (registered trademark) networks. Currently, the following two types of backbone networks exist: a backbone network designed based on the synchronous digital hierarchy/synchronous optical network (SDH/SONET) technique (conventional technique); and a backbone network designed based on the IP Ethernet technique (new technique). To reduce the inefficiency of arrangements and maintenances due to coexistence of these two network types, it has been discussed that the backbone networks are consolidated into IP Ethernet-based backbone networks by forming SHD/SONET signals into IP Ethernet packets. Specifically, the IP Ethernet-based backbone networks are represented by networks using T-MPLS techniques defined in Non-Patent Document 1 (ITU-T G.8110.1/Y. 1370.1 Architecture of Transport MPLS (T-MPLS) layer network), Non-Patent Document 2 (ITU-T G.8112/Y. 1371 Interfaces for the Transport MPLS (T-MPLS) Hierarchy), and Non-Patent Document 3 (ITU-T G.8112/Y. 1381 Characteristics of Transport MPLS equipment functional blocks).

The MPLS features high-speed transfer of IP (Internet Protocol) packetized user data by means of a label header. The data transfer according to the MPLS technique is different from IP packet transfer (in layer 3) performed by a conventional router. Label information is embedded in an IP packet according to the MPLS technique. Thus, the MPLS technique allows for high-speed packet transfer in a layer 2 without transfer in a layer 3. The user data means a payload portion obtained by excluding a section overhead (SOH) from a SDH/SONET signal.

### SUMMARY OF THE INVENTION

FIGS. 1 and 2 each show a signal obtained by packetizing user data by means of a label header. The label header indicates a four-byte length virtual circuit label switching protocol (VCLSP) header and a four-byte length tunnel label switching protocol (TLSP) header. The user data packetized by means of the VCLSP header and the TLSP header is called a MPLS packet.

The purpose of use of the VCLSP and TLSP headers is described with reference to FIG. 3. FIG. 3 shows the configuration of a basic MPLS network and illustrates the case where user data is delivered from a client device 1-1 (10-1) to a client device 2-1 (20-1). In FIG. 3, the user data is a SDH/SONET signal as an example. First, an MPLS edge device 1 (11-1) terminates an overhead of a signal transmitted from the client device 1-1 (10-1). Then, the MPLS edge device 1 (11-1) extracts user data from the signal and encapsulates the user data by means of a VCLSP header. The VCLSP header clarifies the destination of the data among client devices. FIG. 3 shows the route of the data from the client device 1-1 (11-1) to the client device 2-1 (20-1) by using VCLSP. It should be noted that the overhead includes address information (such as an IP address and a destination address) of client devices 2-1 to 2-n (20-1 to 20-n).

Then, an MPLS core device 1 (12-1) attaches a TLSP header (TLSP1 header) to the data. The packet transfer (hereinafter referred to as label switching) can be performed from end to end in the MPLS network by encapsulating a VCLSP header by means of a TLSP header while the VCLSP header is not checked. In FIG. 3, the MPLS core device 1 (12-1) attaches the TLSP1 header to the data and then performs label switching to transfer the data to a MPLS core device 2 (12-2). The MPLS core device 2 (12-2) replaces the TLSP1 header with another TLSP header (TLSP2 header) and then performs label switching to transfer the user data to a MPLS core device 3 (12-3). The MPLS core device 3 (12-3) terminates the TLSP2 header and then performs label switching to transfer the user data to an MPLS edge device 2 (11-2). The MPLS edge device 2 (11-2) terminates the VCLSP header and then delivers the user data to the client device 2-1 (20-1). When the user data is transferred in multiple MPLS networks, multiple TLSP headers are attached to the user data as shown in FIG. 2 (the attachments of multiple TLSP headers are called a label stack).

The label stack is one of features of the MPLS technique. In an asynchronous transfer mode (ATM), a virtual path identifier (VPI) and a virtual channel identifier (VCI) are allocated to an ATM cell header. A TLSP header for the MPLS is considered to correspond to the VPI, and a VCLSP header for the MPLS is considered to correspond to the VCI. However, the ATM does not support three or more labels.

As shown in FIGS. 1 and 2, the user data region of each of the MPLS packets has n byte length. This indicates that the MPLS packetization can be performed irrespective of the user data.

In recent years, many different types of signals have been provided based on the purposes of use. Therefore, it is desirable that SDH/SONET signals and other types of signals can be packetized by means of the MPLS. The signals include signals used for Ethernet (registered trademark) standardized by IEEE802.3 and signals used for the fiber channel standardized by the American National Standards Institute T11 technical committee (ANSI T11). The Ethernet is a mainstream of local area networks (LANs). The fiber channel is a mainstream of storage area networks (SANs).

FIG. 4 shows a list of signals that are used in a MPLS network. The types of signals widely vary, and the signal transfer rates are in a wide range from 50 Mbps to 40 Gbps. The MPLS technique features high-speed label switching (high-speed data transfer) after packetization of signals by means of label headers irrespective of the types of signals as described above.

As described above, a high-speed data delivery can be performed by means of the label switching technique in a MPLS network irrespective of the types of signals. However, when the TLSP or VCLSP label header includes a bit error during transfer of a packet between MPLS devices, the MPLS packet may be delivered in an inappropriate route or toward an inappropriate destination.

The present invention is to provide a highly reliable network system that can prevent a misdelivery even when a bit error occurs in a label.

As an example, a network system according to the present invention includes a first terminal, a second terminal, and a communication controller that communicates with the first terminal. The communication controller has a receiving processor, a first-label attachment section, and a first-label error control information attachment section. The receiving processor receives from the first terminal a first message containing data and address information of the second terminal. The first-label attachment section attaches a first label to the data to form the data into (IP) packetized data. The first-label error control information attachment section attaches first label error control information to the IP-packetized data.

According to the present invention, a highly reliable MPLS network that allows various types of signals to be transferred and prevents an MPLS packet from being misdelivered can be built.

### BRIEF DESCRIPTION OF THE DRAWINGS

FIG. 1 is an explanatory diagram showing an MPLS packet that is used in an MPLS network.

FIG. 2 is an explanatory diagram showing an MPLS packet that is used in an MPLS network and has MPLS labels stacked therein.

FIG. 3 is an explanatory diagram showing an MPLS network in which an MPLS packet is used.

FIG. 4 is a list of types of signals that are used in an MPLS network.

FIG. 5 is an explanatory diagram showing an MPLS packet using an HEC function.

FIG. 6 is an explanatory diagram showing an MPLS packet using an HEC function and having MPLS labels stacked therein.

FIG. 7 is an explanatory diagram showing an MPLS packet using an HEC function and having a bit interleaved parity-8 (BIP-8) attached thereto.

FIG. 8 is an explanatory diagram showing a hardware configuration of an MPLS edge device having an HEC function.

FIG. 9 is an explanatory diagram showing a hardware configuration of an MPLS core device having an HEC function.

FIG. 10 is a list of functional blocks of the MPLS edge device having the HEC function and functional blocks of the MPLS core device having the HEC function.

FIG. 11 is an explanatory diagram showing an MPLS network including MPLS edge devices having respective HEC functions and MPLS core devices having respective HEC functions.

### DESCRIPTION OF THE PREFERRED EMBODIMENTS

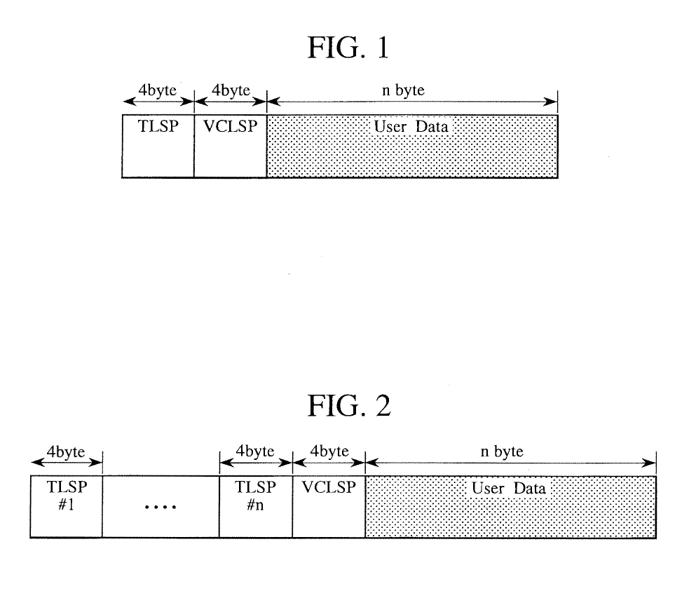

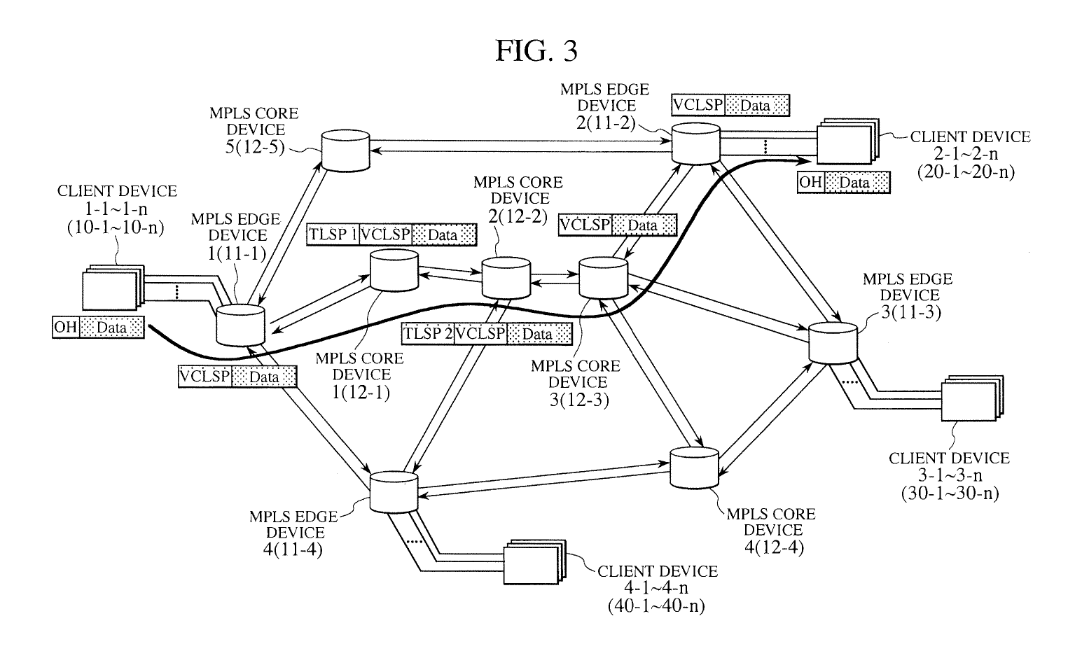

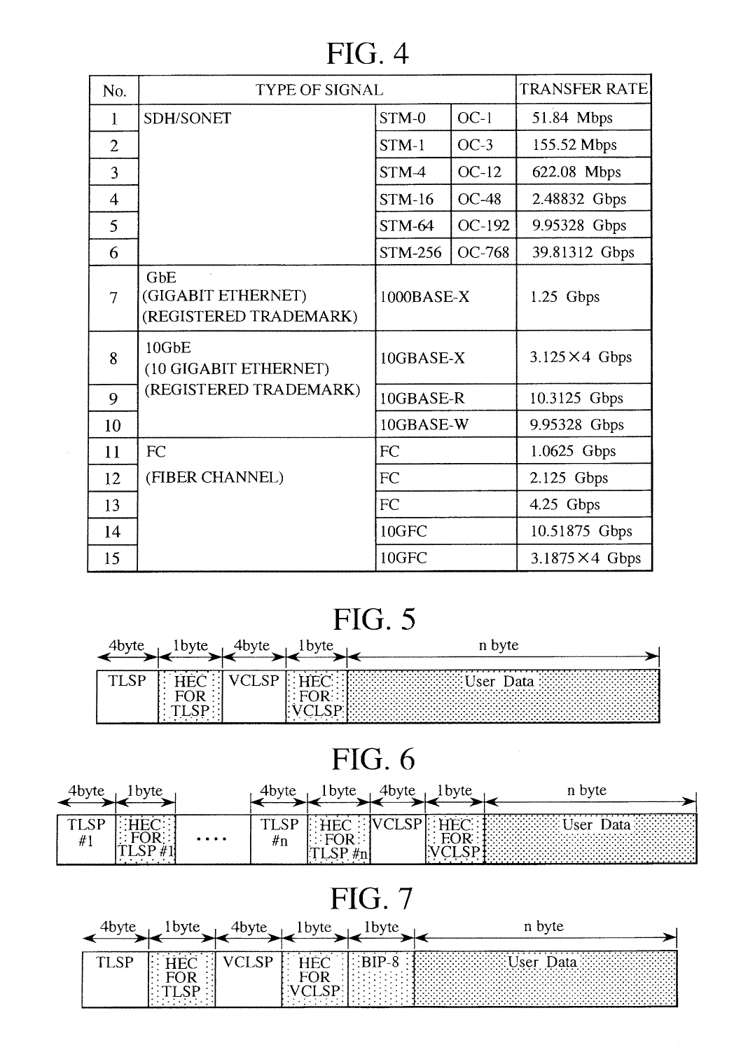

A typical embodiment of the present invention is described below with reference to the accompanying drawings. The following description assumes that all the signals shown in FIG. 4 can be arbitrarily packetized and formed in the user data regions shown in FIGS. 1 and 2.

In the present embodiment, a header error control (HEC) function that controls a label error is attached to each of VCLSP and TLSP headers. FIGS. 5 and 6 each show the configuration of a packet having HEC functions attached thereto. One-byte HEC functions are attached to all the VCLSP and TLSP headers, respectively. Each of the HEC functions is capable of correcting a one-bit error and detecting an error of 2 or more bits. A transmitting-side MPLS device performs a calculation on a corresponding label according to a generating polynomial, and attaches the calculation result to an HEC region.

A receiving-side MPLS device performs a calculation on the label and the HEC function according to an HEC expression to obtain the calculation result of 8 bits. The total of the label and the HEC function is 5 bytes. A syndrome value is defined for the eight-bit calculation result. The eight-bit value can specify, as an error, any one bit of the 5 bytes consisting of the label and the HEC function. When all the 8 bits are zero, there is no error in the label and the HEC function. When the 8 bits are values other than the syndrome value, there is an error of 2 or more bits.

When the receiving-side MPLS device determines that there is an error of 2 or more bits as a result of the HEC calculation, the location of the error cannot be specified. Thus, the bit error of the label cannot be corrected. When the bit error cannot be corrected, or when an error of 2 or more bits occurs, the receiving-side MPLS device discards the packet to avoid a misdelivery.

In addition, each of the transmitting-side and receiving-side MPLS devices may perform a BIP-8 calculation on a user data region as shown in FIG. 7. Each device can use a BIP-8 to monitor whether or not a bit error is present in the user data. Specifically, the transmitting-side MPLS device inserts the result of the BIP-8 calculation into a BIP-8 region of the next frame. The receiving-side MPLS device performs the BIP-8 calculation on the user data region of the received packet to compare the user data region with the BIP-8 region of the next frame and thereby monitor whether or not a bit error is present.

In each of the configurations of the MPLS packets shown in FIGS. 5 to 7, the label(s) and the HEC function(s) are alternately arranged. Each of the arrangements is made based on the hardware configuration of an MPLS network in which the MPLS packet is used. The MPLS technique was developed on the assumption that a plurality of labels is stacked in an MPLS packet. A one-bit S (bottom-of-stack) bit is assigned to each label. The S bit is used to determine whether or not the label to which the S bit is assigned is the last one of the stacked labels. When the S bit indicates 1, the label to which the S bit is assigned is the last one. When the S bit indicates 0, there is a label next to the label to which the S bit indicating 0 is assigned.

The HEC correction is performed under the condition that the HEC function is located at a region of the fifth byte from the top of the MPLS packet. The determination (hereinafter referred to as S bit determination) using the S bit is made after the HEC correction under the condition that the first four bytes of the MPLS packet consist of the label. When the S bit indicates 0, the label is still stacked in the MPLS packet. Thus, the HEC correction is performed under the condition that the second HEC function is located at a region of the tenth byte from the top of the MPLS packet. Then, the S bit determination is made under the condition that the sixth to ninth bytes of the MPLS packet consist of the label. After that, the HEC correction and the S bit determination are repeated until an S bit indicating 1 is detected.

As described above, it is necessary that the label(s) and the HEC function(s) be alternately arranged since the S bit determination is made.

The following describes a detail circuit configuration designed to achieve the above-mentioned function. The MPLS hardware configuration is mainly classified into an MPLS edge device and an MPLS core device. The MPLS edge device is located at the edge of the MPLS network, while the MPLS core device is located in the MPLS network.

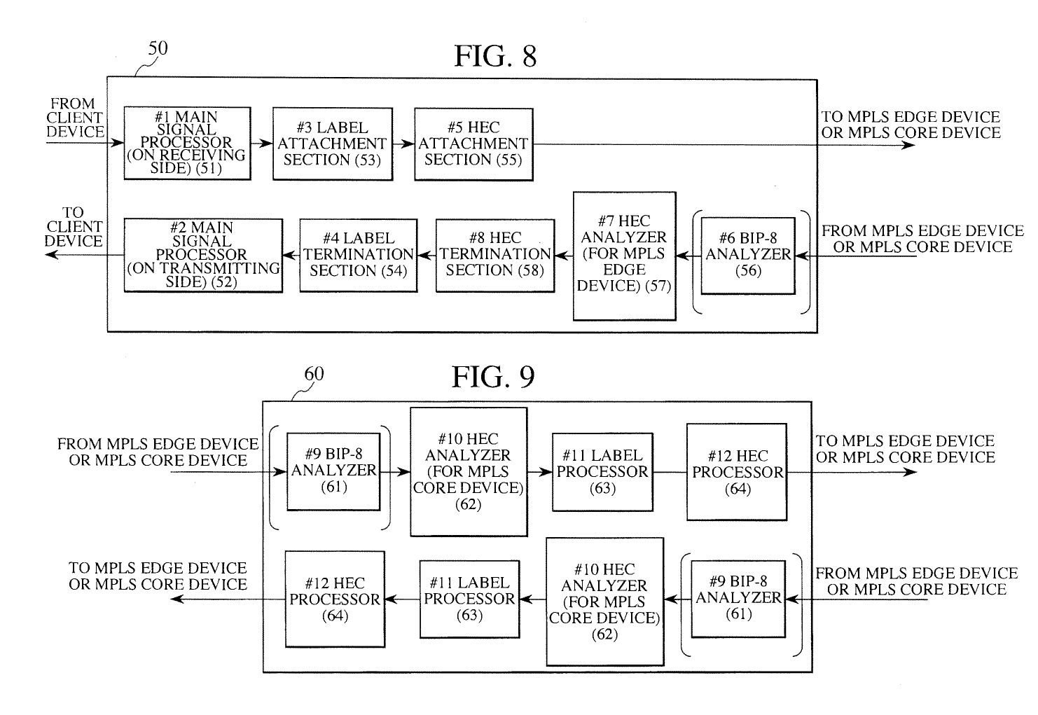

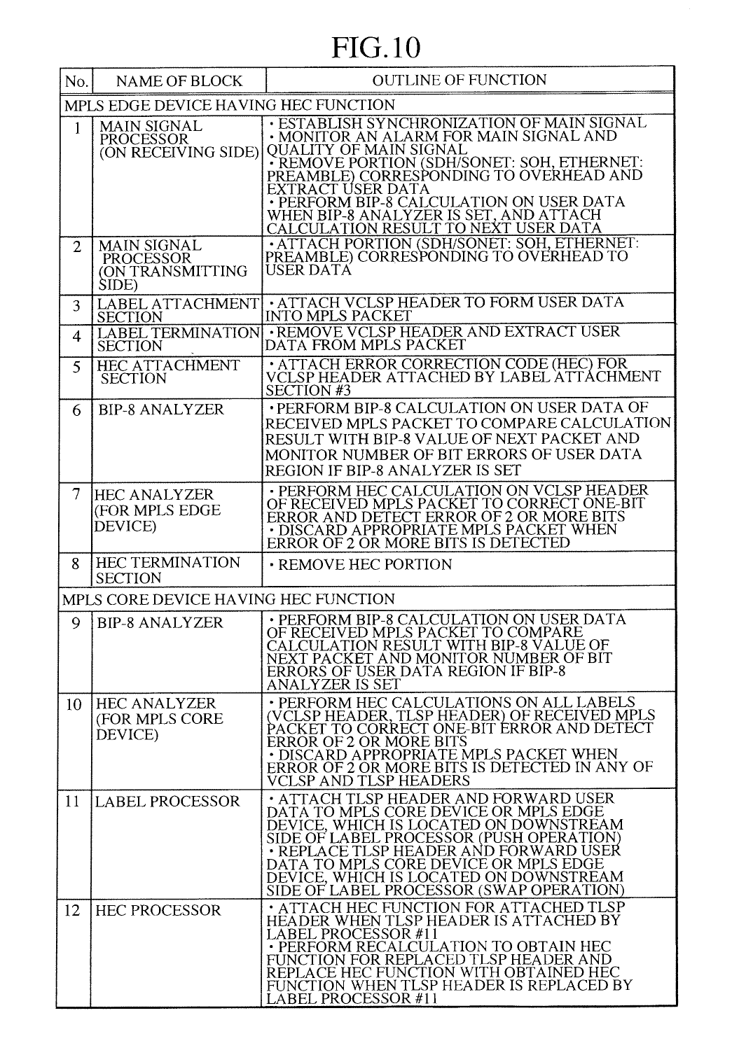

FIG. 8 shows a circuit configuration of an MPLS edge device (50) having an HEC function. FIG. 10 is a list of outlines of functions of functional blocks. The functional blocks indicated by numbers shown in FIG. 10 are denoted by symbols # in FIGS. 8 and 9. The MPLS edge device (50) uses receiving-side functional blocks to receive a signal from a client device and form the signal into an MPLS packet. First, a main signal processor (51) #1 (arranged on the receiving side) terminates an overhead and the like of the signal, and extracts user data from the signal. Then, a label attachment section (53) #3 attaches a VCLSP header to the user data. An HEC attachment section (55) #5 attaches a HEC function for the attached VCLSP header to the user data to form the user data into an MPLS packet.

The MPLS edge device uses transmitting-side functional blocks to receive a packet from an MPLS device and extract user data from the received packet. First, an HEC analyzer (for the MPLS edge device) (57) #7 performs an error detection on a VCLSP header of the received packet and corrects an error if the error is detected. An error of 2 or more bits in a label cannot be corrected and the error may result in a misdelivery of the packet. Thus, it is necessary that the packet be discarded. If the number of discarded packets is counted and acquired as statistic information, an MPLS packet(s) in the network can be managed. Subsequently, an HEC termination section (58) #8 terminates an HEC function of the packet, and a label termination section (54) #4 terminates a VCLSP header of the packet. In this way, the MPLS edge device (50) extracts only user data. A main signal processor (52) #2 (arranged on the transmitting side) attaches an overhead and the like to the user data, and transmits the thus-configured signal to a client device.

If a BIP-8 analyzer (56) #6 is set in the MPLS edge device (50), the BIP-8 analyzer (56) #6 monitors whether or not a bit error is present in the user data. However, the BIP-8 analyzer (56) #6 is not necessary. This functional block may be removed when necessary.

FIG. 9 shows a circuit configuration of an MPLS core device (60) having an HEC function. FIG. 10 shows the outlines of the functions of the functional blocks. First, the MPLS core device (60) receives an MPLS packet. Then, an HEC analyzer (for the MPLS core device) (62) #10 performs an error detection on all labels (VCLSP, TLSP) and corrects an error(s) if the error(s) is detected. When an error of 2 or more bits is present in any of the labels, it is recommended that the MPLS core device (60) discard the packet. Subsequently, a label processor (63) #11 attaches an additional label to the packet (push operation) and replaces a label of the packet with another label (swap operation). When the label is attached to the packet by the label processor (63) #11, an HEC processor (64) #12 attaches an additional HEC function to the packet. When the label processor (63) #11 replaces the label of the packet with another label, the HEC processor (64) #12 replaces an HEC function for the replaced label with an HEC function for the other label. The MPLS core device includes the two circuit systems to realize bidirectional communications.

When a BIP-8 analyzer (61) #9 is set in the MPLS core device (60), the BIP-8 analyzer (61) #9 monitors whether or not a bit error is present in the user data. However, as the BIP-8 analyzer (56) #6 is not necessary, this functional section may be removed when necessary.

The following describes the configuration of an MPLS network including the MPLS edge device (50) (shown in FIG. 8) having the HEC function and the MPLS core device (60) (shown in FIG. 9) having the HEC function.

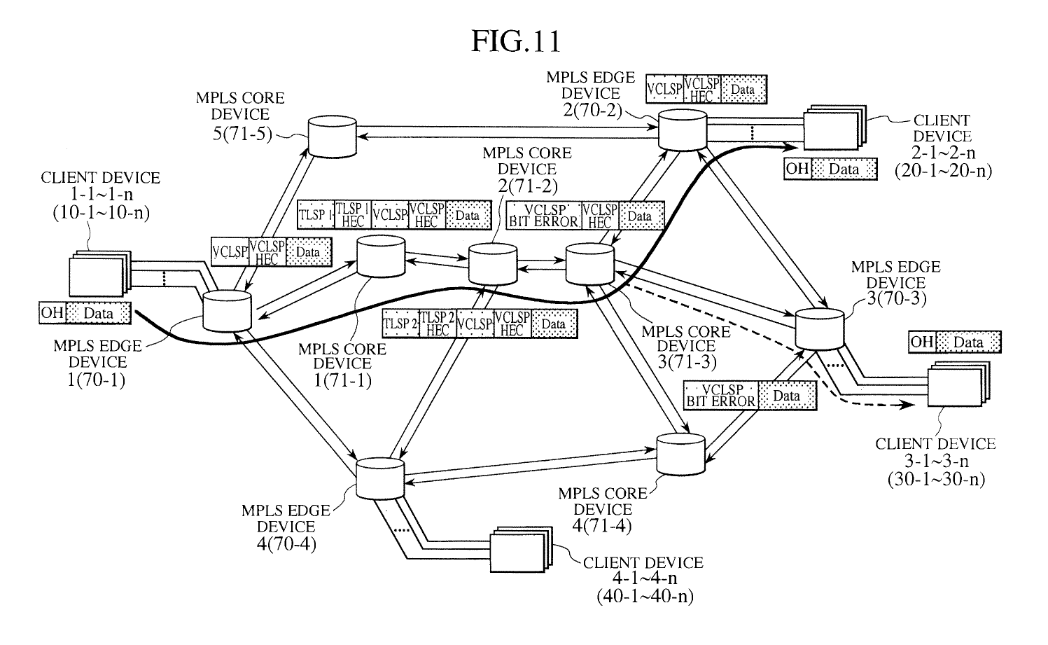

FIG. 11 shows the detail configuration of the MPLS network. The MPLS edge device and the MPLS core device have the HEC functions, respectively.

As shown in FIG. 8, the MPLS edge device (50) having the HEC function uses the receiving-side blocks to packetize a signal received from a client device. First, the MPLS edge device extracts user data from the signal received from the client device. Then, the MPLS edge device attaches a VCLSP header to the user data and attaches an HEC function for the VCLSP header to the user data to form the user data (payload portion) into an MPLS packet. The MPLS edge device transmits the MPLS packet to another MPLS edge device or an MPLS core device, which is located on the downstream side of the MPLS edge device (50).

The MPLS edge device (50) uses the transmitting-side sections to extract user data from an MPLS packet received from another MPLS edge device or an MPLS core device. First, the MPLS edge device (50) uses the HEC function to perform an error detection on the VCLSP header of the received MPLS packet and correct an error. When an error of 2 or more bits is present in the received packet, the error cannot be corrected by using the HEC function. Thus, it is recommended that the MPLS edge device (50) discard the packet. Subsequently, the MPLS edge device (50) terminates the HEC function and the VCLSP header, attaches an overhead and the like to the user data. Then, the MPLS edge device (50) transmits the thus-configured signal to the client device.

As shown in FIG. 9, the MPLS core device (60) having the HEC function receives an MPLS packet and uses the HEC function to perform an error detection on all labels of the received MPLS packet and correct an error(s). When an error of 2 or more bits is present in any of the labels, the error cannot be corrected by using the HEC function. Thus, it is recommended that the MPLS core device (60) discard the packet. Subsequently, the MPLS core device (60) attaches a label header to user data of the received packet (push operation) and replaces a label of the received packet with another label (swap operation). When the MPLS core device (60) attaches the label, the MPLS core device (60) attaches an HEC function to the received packet. When the MPLS core device (60) replaces the label of the received packet with another label, the MPLS core device (60) replaces an HEC function for the replaced label with another HEC function.

The MPLS core device (60) may perform a bit interleaved parity-8 (BIP-8) calculation on the user data region when necessary. The MPLS core device (60) can use a BIP-8 to monitor whether or not a bit error is present in the user data. Specifically, a transmitting-side MPLS device inserts the result of the BIP-8 calculation into the region of a BIP-8 of the next frame. A receiving-side MPLS device performs a BIP-8 calculation on the user data region of the received packet to compare the user data region with the BIP-8 region of the next frame and thereby monitor whether or not a bit error is present.

The following describes the case where user data received from the client device 1-1 (10-1) is delivered to the client device 2-1 (20-1). First, an MPLS edge device 1 (70-1) having an HEC function receives a signal from the client device 1-1 (10-1) and terminates an overhead of the received signal to extract user data from the signal. Then, the MPLS edge device 1 (70-1) forms the user data into an MPLS packet by means of a VCLSP header and an HEC (VCLSP HEC) function for the VCLSP header. The MPLS edge device 1 (70-1) performs label switching to transfer the MPLS packet to an MPLS core device 1 (71-1) having an HEC function.

The MPLS core device 1 (71-1) having the HEC function uses the VCLSP HEC function to perform an error detection. When a one-bit error is present in the MPLS packet, the MPLS core device 1 (71-1) corrects the one-bit error. When an error of 2 or more bits is present in the MPLS packet, the MPLS core device 1 (71-1) discards the MPLS packet. After that, the MPLS core device 1 (71-1) attaches a TLSP header (TLSP1 header) and an HEC (TLSP1 HEC) function for the TLSP1 header to the MPLS packet. Then, the MPLS core device 1 (71-1) performs label switching to transfer the MPLS packet to an MPLS core device 2 (71-2) having an HEC function.

The MPLS core device 2 (71-2) having the HEC function performs an error detection by means of a VCLSP HEC function and a TLSP1 HEC function. When a one-bit error is present in at least one of the VCSLP header and the TLSP1 header, the MPLS core device 2 (71-2) corrects the error. When an error of 2 or more bits is present in at least one of the VCSLP header and the TLSP1 header, the MPLS core device 2 (71-2) discards the MPLS packet. After that, the MPLS core device 2 (71-2) replaces the TLSP1 header with another TLSP header (TLSP2 header), and replaces the TLSP1 HEC function with an HEC function (TLSP2 HEC function) for the TLSP2 header. Then, the MPLS core device 2 (71-2) performs label switching to transfer the MPLS packet to an MPLS core device 3 (71-3) having an HEC function.

The MPLS core device 3 (71-3) having the HEC function performs an error detection by means of the VCLSP HEC function and the TLSP2 HEC function. When a one-bit error is present in at least one of the VCSLP header and the TLSP2 header, the MPLS core device 3 (71-3) corrects the error. When an error of 2 or more bits is present in at least one of the VCSLP header and the TLSP2 header, the MPLS core device 3 (71-3) discards the MPLS packet. After that, the MPLS core device 3 (71-3) terminates the TLSP2 header, and perform label switching to transfer the MPLS packet to an MPLS edge device 2 (70-2) having an HEC function.

Now consider the case where a bit error occurs in the VCLSP header and the VCLSP header becomes a VCLSP header for a client device 3-1 (30-1) when the MPLS core device 3 (71-3) receives the MPLS packet. If a VCLSP HEC function is not provided in the MPLS packet, the MPLS core device 3 (71-3) performs the label switching to transfer the MPLS packet to an MPLS edge device 3 (70-3) according to the VCLSP header with the bit error. Thus, the user data is misdelivered to a client device 3-1 (30-1) from the MPLS edge device 3 (70-3). According to the present invention, however, the HEC function is used to correct an error of the VCLSP header, and the label switching is performed to transfer the packet to the MPLS edge device 2 (70-2). Accordingly, the user data can be properly delivered to the client device 2-1 (20-1).

As described above, since the MPLS edge devices and the MPLS core devices have the HEC functions, respectively, the user data can be properly delivered to the client device 2-1 (20-1) without being misdelivered to the client device 3-1 (30-1) due to a bit error. Therefore, a highly reliable MPLS network can be achieved.

There is a concern that when a bit error occurs in an MPLS label header, data is misdelivered to an inappropriate destination in an MPLS network. To address the concern, HEC functions are respectively attached to MPLS label headers (VCLSP header and TLSP header) to correct an error(s) present in the MPLS label headers and thereby prevent the data from being misdelivered. Therefore, a highly reliable MPLS network can be provided.

What is claimed is:

1. A network system comprising a first terminal, a second terminal, and a communication controller that communicates with the first terminal, the communication controller including:
a receiving processor that receives from the first terminal a first message including data and address information of the second terminal;
a first-label attachment section that attaches a first label to the data to form the data into IP packetized data; and
a first-label error control information attachment section that attaches first label error control information to the IP-packetized data.

2. The network system according to claim 1, further comprising a relay device that communicates with the communication controller,
wherein the communication controller transmits, to the relay device, the IP-packetized data encapsulated by attaching the first label.

3. The network system according to claim 1, wherein the first label is a VCLSP header.

4. The network system according to claim 1, further comprising a relay device that communicates with the communication controller, the relay device including:
a second label attachment section that attaches a second label to the IP-packetized data having the first label error control information attached thereto; and
a second label error control information attachment section that attaches second label error control information to the IP-packetized data having the second label attached thereto;
wherein the communication controller transmits, to the relay device, the IP-packetized data encapsulated by attaching the first label.

5. The network system according to claim 4, wherein the second label attachment section and the second label error control information attachment section perform the attachments such that the first label error control information is located between the first and second labels and that the second label error control information is located between the second label and the data.

6. The network system according to claim 4, wherein the second label attachment section attaches the second label to the IP-packetized data having the first label error control information attached thereto to encapsulate the IP-packetized data.

7. The network system according to claim 1, wherein the second label is a TLSP header.

8. The network system according to claim 1, wherein the communication controller has a label error control information analyzer that detects whether or not an error is present in the first label on the basis of the first label error control information when the communication controller receives the IP-packetized data having the first label error control information attached thereto.

9. The network system according to claim 2, wherein the relay device has a label error control information analyzer that detects whether or not an error is present in the first label on the basis of the first label error control information when the relay device receives the IP-packetized data having the first label error control information attached thereto.

10. The network system according to claim 2, wherein the relay device has a BIP-8 calculation analyzer that performs a BIP-8 calculation on the data and attaches information indicating the result of the BIP-8 calculation to the data.

11. The network system according to claim 1, wherein the communication controller has a BIP-8 calculation analyzer that performs a BIP-8 calculation on the data and attaches information indicating the result of the BIP-8 calculation to the data.
